(19) United States
(12) Patent Application Publication
(10) Pub. No.: US 2013/0205015 A1
(43) Pub. Date: Aug. 8, 2013

(54) Method and Device for Analyzing Data Intercepted on an IP Network in order to Monitor the Activity of Users on a Website

(71) Applicants: Gregory Crapella, Gennevilliers (FR); Thibaud Bazelle, Montreal (CA); Laurent Chollon, Gennevilliers (FR)

(72) Inventors: Gregory Crapella, Gennevilliers (FR); Thibaud Bazelle, Montreal (CA); Laurent Chollon, Gennevilliers (FR)

(73) Assignee: THALES, Neuilly Sur Seine (FR)

(21) Appl. No.: 13/699,262

(22) PCT Filed: May 20, 2011
(86) PCT No.: PCT/FR2011/051153

§ 371 Date: Apr. 22, 2013

(30) Foreign Application Priority Data
May 20, 2010 (FR) 10 02132

(51) Int. Cl. H04L 12/26

(52) U.S. Cl. CPC H04L 43/04
USPC 709/224

(57) ABSTRACT

A method is provided. The method includes the steps acquiring a complete data frame from an HTTP request, selecting the data frame acquired if the binary structure thereof meets a plurality of conditions including at least one condition corresponding to the IP layer of the frame, at least one condition corresponding to the transport layer of the frame and at least one condition corresponding to the application layer of the frame, extracting data of interest from the application layer of the selected frame and recording the extracted data in a database.

### BACKGROUND

To monitor a particular website, the legally authorized administration (denoted LAA in this document) of the state receives one or more log files from the host of the website or its administrator, said files containing the log of connections on the access server for the website.

This method involves informing the host or administrator that the website it is hosting is being watched.

Furthermore, if the host or administrator does not fall under the national law, the website being hosted abroad even though the users of that website are nationals of the state in question, it is difficult for the LAA to compel the foreign host or administrator to provide the log files.

### SUMMARY OF THE INVENTION

An objection of the present invention provides an analysis method and device enabling the real-time processing of a data flow intercepted on an IP communication network for detailed monitoring of the activity of users of a website of interest.

The present invention provides a method for analyzing intercepted HTTP requests on an IP network to monitor the activity of the users of a predetermined website, including the following steps:

acquiring the complete data frame from an HTTP request;

selecting the acquired data frame if the binary structure thereof meets a plurality of conditions comprising at least one condition corresponding to the IP layer of the frame, at least one condition corresponding to the transport layer of the frame, and at least one condition corresponding to the application layer of the frame;

extracting data of interest from the application layer of the selected frames; and

recording the extracted data in a database.

According to specific embodiments, the method may include one or more of the following features, considered alone or according to all technically possible combinations:

the selection step allows the selection of a frame whereof the transport layer is a TCP layer and the application layer is an HTTP layer.

in the selection step, said at least one condition on the IP layer, respectively said at least one condition on the TCP layer, consists of comparing the length of a packet of bits included in the acquired frame, that packet being considered an IP packet, a TCP packet, respectively, with a predefined header length of an IP packet, a TCP packet, respectively.

in the selection step, said at least one condition on the IP layer, said at least one condition on the HTTP layer, respectively, consists of applying, on the header of a packet of bits included in the acquired frame, that packet being considered an IP packet, an HTTP packet, respectively, a mask to extract a group of bits and compare that group of bits with an expected binary value for a parameter present in the header of an IP packet, in the header of an HTTP packet, respectively.

between the step consisting of extracting the data from the application layer of said frame and recording that data in a database, the method includes an additional step consisting of shaping the extracted data according to a predetermined model, preferably by associating metadata therewith.

The present invention also provides a device for implementing the method according to any one of claims 1 to 5, characterized in that it comprises:

means for acquiring a complete data frame of an intercepted HTTP request on an IP communication network to which said device is connected;

selection means capable of verifying the plurality of conditions on the binary structure of an acquired data frame obtained as output from the acquisition means, and having at least one routine for verifying a condition corresponding to the IP layer of the frame, at least one routine for verifying a condition corresponding to the transport layer of the frame, and at least one routine for verifying a condition corresponding to the application layer of the frame;

an extraction means capable of extracting data from the application layer of a selected data frame obtained as output from the selection means;

recording means capable of storing the extracted data obtained as output from the extraction module in a database.

According to particular embodiments, the device may include one or more of the following features, considered alone or according to all technically possible combinations:

the selection means is adapted to select and acquire data frames whereof the transport layer is a TCP layer and whereof the application layer is an HTTP layer;

the device includes a processing stage including a plurality of processing server computers, each processing server computer being connected to said IP communication network and including instancing of said acquisition, selection and extraction means;

the device also includes a storage stage including a plurality of storage server computers, each storage server computer being connected to said plurality of processing server computers, being associated with at least one database, and including instancing of said storage means capable of storing the extracted data communicated by a processing server computer in the database associated with the considered storage server computer;

the device also includes a retrieval stage including at least one retrieval computer including means for querying the various databases of the storage stage;

The configurable nature of the device, i.e. the separation into modules of the processing, storage, and retrieval steps, and the extensibility of the device, i.e. the possibility of having several instances of each module, allows the real-time analysis of an IP dataflow having a very high throughput and/or a very large volume.

Owing to the implementation of the selection step including an “in-depth” analysis of the incident IP data, i.e. an analysis of the binary level of the frames, the method enables the real-time processing of a dataflow having a very high throughput, in the vicinity of several Gbits. The step for extracting data of interest for monitoring of the website is only performed downstream of the selection step, on a reduced number of selected frames.

### BRIEF DESCRIPTION OF THE DRAWINGS

The invention and the advantages thereof will be better understood upon reading the following description, provided solely as an example and done in reference to the appended drawings, in which:

FIG. 1 is a diagrammatic illustration of the hardware architecture for the implementation of the processing method;

FIG. 2 is a diagrammatic illustration of the various software allowing implementation of the processing method;

FIG. 3 is a diagrammatic flowchart illustrating the various steps of the analysis method;

FIG. 4 is a detailed flowchart illustrating the filtering step of the processing method; and

FIG. 5 illustrates the various layers of the frame.

### DETAILED DESCRIPTION

Generally speaking, a computer includes storage means, such as random access memory RAM, read-only memory ROM, and a storage space such as one or more hard drives, and computation means, such as processor, capable of running the instructions from computer programs that are stored in the storage means of the computer.

A computer also includes input/output interfaces adapted to connect the computer to at least one network allowing it to communicate with at least one other computer connected to that network.

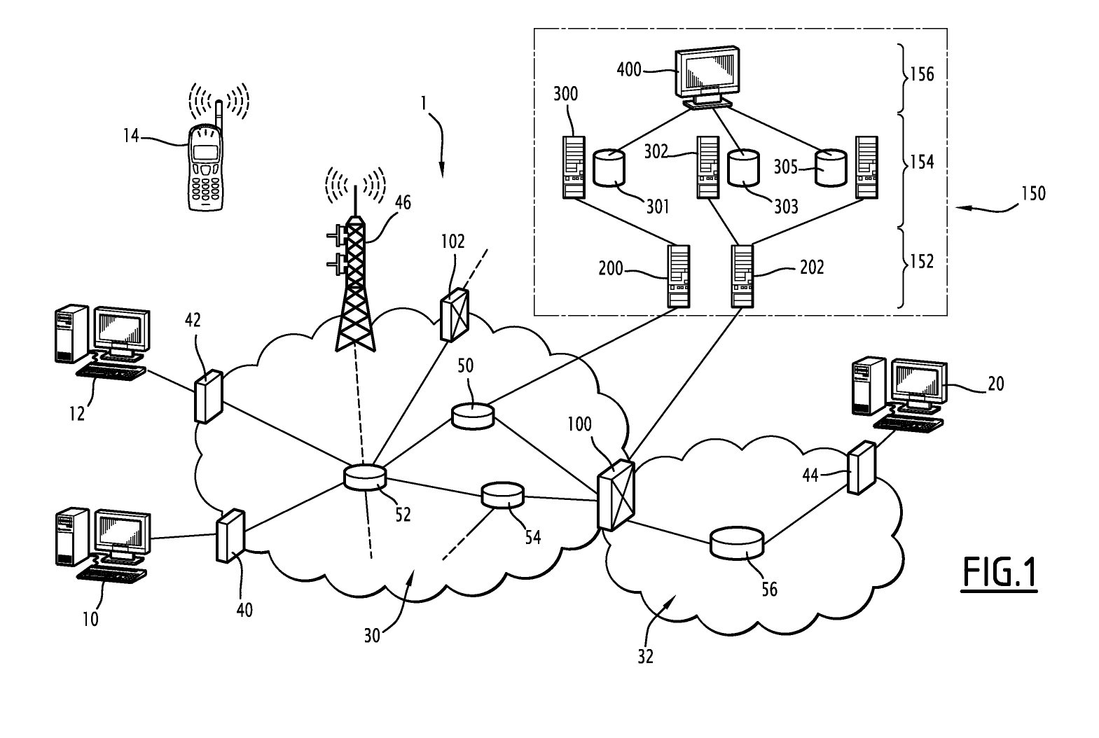

In reference to FIG. 1, the architecture 1 includes the first client computer 10, a second client computer 12, and a third client computer 14. The client computers 10 and 12 are of the personal computer (PC) type, and the client computer 14 is of the mobile phone type capable of connecting to a cellular telephone network such as a 3G network.

The architecture 1 also includes a server computer 20 including an HTTP or Web server. It hosts the website to be monitored.

The architecture 1 includes two IP communication networks. The first network 30 is a network managed by an Internet access provider that can cooperate with the LAA. The second network 32 is managed by another operator. The server 20 is connected to the second network. Alternatively, it belongs to the first network.

The networks 30 and 32 allow IP communication between a client computer 10, 12, 14 and the HTTP server 20. The networks include a plurality of pieces of access equipment 40, 42, 44 and 46 as well as a plurality of router equipment 50, 52 and 54, and interconnection equipment between networks 100 and 102.

A router is able to retransmit an incident IP packet toward a node of the network that the router equipment chooses as a function of the address of the final recipient of the packet, address which the router can read in the incident packet.

Interconnection equipment constitutes a point of access to the network 30 for the other networks. The interconnection equipment 100, 102 is managed by the access provider, in agreement with the other operator(s) of the other networks.

A client computer belonging to a user having a subscription with the access provider may be connected to the first network 30 in various ways. Thus, the client computer 10 is connected to the access equipment 40 by an ADSL connection. The computer 12 is connected to the access equipment 42 by an RTC connection. The mobile phone 14 is connected by a wireless link to the access equipment 46. An IP address is assigned to the client computer when it connects to the access equipment.

The device for implementing the processing method is shown in FIG. 1 and indicated by general reference 150.

The device 150 includes a first processing stage 152. In FIG. 1, the processing stage includes two processing server computers 200 and 202.

One processing server includes an addressable memory space.

A processing server is connected, upstream, to the first IP network. Thus, the first processing computer 200 is connected to the router 50 and the second processing computer 202 is connected to the interconnection equipment 100.

A processing server is connected downstream to one or more storage servers that will now be described.

The device 150 includes a second storage stage 154. In FIG. 1, the storage stage includes three storage server computers 300, 302 and 304. Each storage server is associated with a database 301, 303, 305, respectively.

Lastly, the device 150 includes a retrieval stage 156. In FIG. 1, the retrieval stage includes a retrieval client computer 400. The retrieval client computer is connected to each of the databases 301, 303, 305.

Passive interception software is stored and run on one or more pieces of equipment of the first network managed by the access provider. For example, the interconnection equipment 100 runs interception software. This includes a duplication module of the “port mirroring” type to duplicate all of the HTTP requests passing through the equipment 100.

The interception software includes a filtering module making it possible to filter the duplicated HTTP request including a URL that is part of a list of reference URLs or parts of URLs with which the filtering module is configured. The URL of the monitored website is included in the reference list.

The interconnection equipment 100 is capable of routing an intercepted HTTP request to one of the processing servers 200, 202 of the device 150.

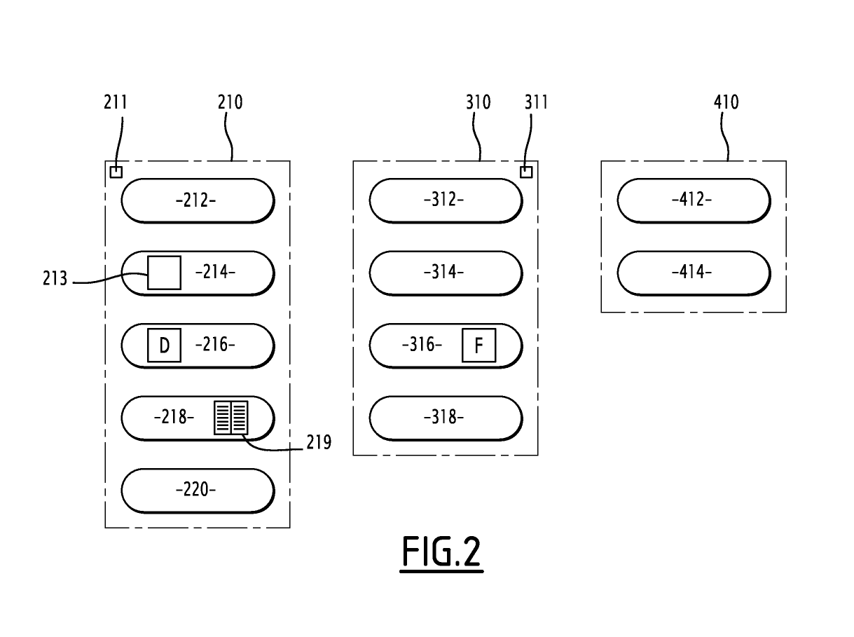

FIG. 2 shows a program which, when run, makes it possible to carry out the processing method. In the described embodiment, this program is broken down into several software applications, which are respectively stored and run by different computers of the device 150.

Processing software 210 is stored on each of the processing servers 200, 202.

The processing software 210 is capable of reading a configuration file 211 containing the various parameters necessary for its operation, such as lengths, expressed in number of bits, corresponding to the length of the headers (“HEADER”) of the packets of the various OSI layers encapsulated in a frame, the extraction masks for groups of bits, and predefined values expected for those groups of bits.

The software 210 includes an acquisition module 212 capable of listening to a predefined port of the processing server, on which port the intercepted frames are incident. The module 212 is capable of acquiring an entire incident frame on the watched port, storing the frame in the addressable memory space of the processing server, and placing, in a stack 213 associated with the frame, a first pointer indicating the address of the first bit of that acquired frame.

The software 210 includes a selection module 214 capable of analyzing the acquired frames in depth. The module 214 is capable of accessing the frames stored in the addressable memory space of the processing server bit by bit. The selection module is capable of adding or subtracting pointers from the stack 213 associated with a frame.

The module 214 includes a plurality of verification routines:

a first routine for verifying a condition on the IP layer, capable of comparing the length of the packet of bits included in a frame with a predefined length of the header of an IP packet,

a second routine for verifying a condition on the IP layer, capable of applying a second mask adapted to extract a second group of bits, and comparing that second group of bits with a second binary value corresponding to an expected value for a protocol parameter present in an IP packet header,

a third routine for verifying a condition on the TCP layer, capable of comparing the length of a packet of bits included in a frame with a predefined length of the header of a TCP packet,

a fourth routine for verifying a condition on the HTTP layer, capable of applying a fourth mask adapted to extract a fourth group of bits, and comparing that fourth group of bits with a fourth binary value corresponding to an expected value for a type parameter, present in an HTTP packet header, and

a fifth routine for verifying a condition on the HTTP layer, capable of applying a fifth mask adapted to extract a fifth group of bits, and comparing that fifth group of bits with at least one fifth binary value corresponding to an expected value for at least one portion of a URL parameter present in an HTTP packet header.

All of these verifications are done without decapsulating the various layers of the OSI model (IP, TCP and HTTP), thereby making it possible to obtain reduced processing times, and therefore to be able to analyze a data flow having a very significant throughput.

The software 210 also includes a module 216 for extracting data contained in an HTTP packet. The module 216 generates data as output, and adds associated metadata. All of this data is called D.

The processing software 210 includes a module 218 for selecting the storage server from amongst the different servers making up the storage stage 154. The module 218 includes an occupancy table 219 providing the address for the different storage servers 300, 302, 304, as well as their respective instantaneous occupancy statuses from among the “free” and “occupied” statuses.

Lastly, the processing software 210 includes an encoding and transmission module 220 capable of taking, as input, the address of the server chosen by the module 218, the port used, and the data produced by the module 216, then communicating that data D to the selected storage server. That data may be encrypted, for example using the AES 256 encryption code known by those skilled in the art.

Storage software 310 is run on each of the storage servers 300, 302, 304.

The storage software 310 is capable of reading a configuration file 311 containing various parameters necessary for its operation.

The software 310 includes an acquisition module 312 capable of listening to a predefined port of the storage server and acquiring the entering data D.

The software 310 includes a decoding module 314 capable of extracting the data.

The software 310 includes a module 316 capable of decoding the metadata to the data D and storing all of that data in a file F. The latter is placed in a particular directory of an archiving structure including a plurality of directories.

Lastly, the software 310 includes a storage module 318 capable of monitoring the filling level of each of the directories of the archiving structure, comparing that level with a threshold value, and storing the contents of a directory in a particular table of the database associated with the storage server.

Retrieval software 410 can be run by the retrieval server 400.

The software 410 includes a man/machine interface 412 making it possible to develop complex query requests for the database 301, 303, 305.

The software 410 includes a module 414 for querying the database. It is capable of interpreting a complex request in a plurality of requests according to the query language used by the database. The module 414 can send a query request to the database 301, 303, 305, and receive the corresponding responses. It is capable of aggregating those responses before sending them to the interface module 412.

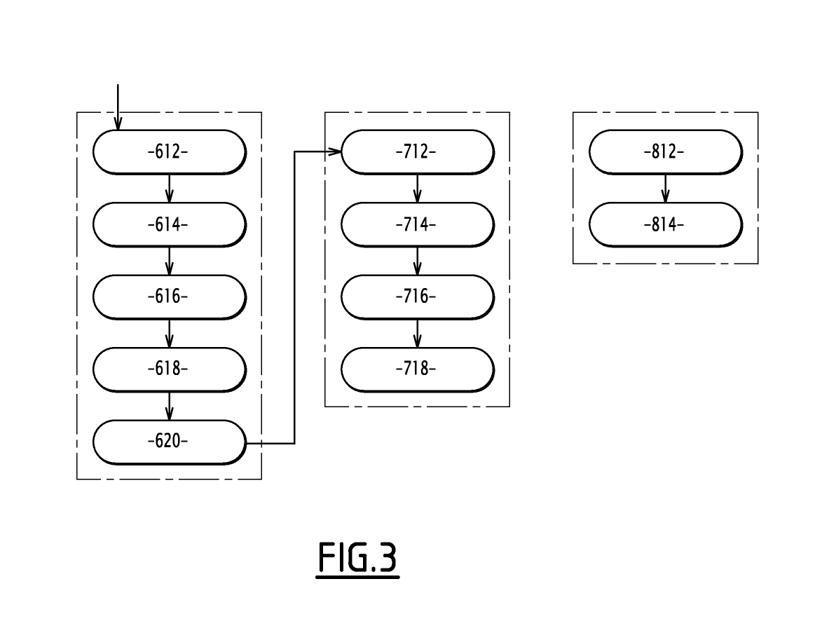

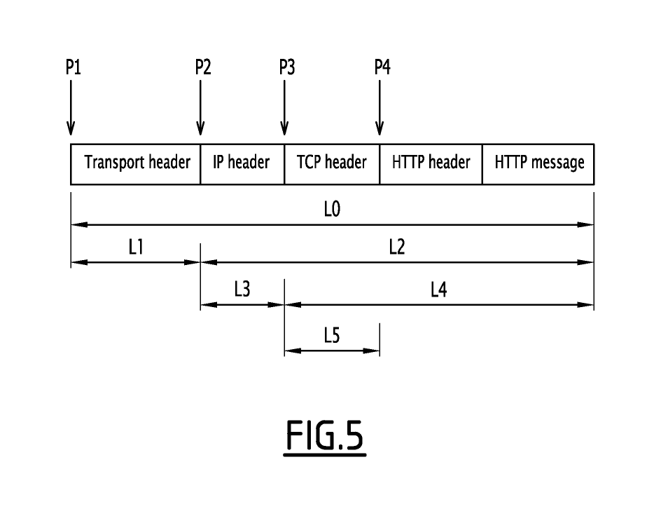

The analysis method will now be described in reference to FIGS. 3 and 4, FIG. 5 recalling the binary structure of a frame.

The server 20 hosts a website on which users exchange data (such as written messages, photos, videos, binary files), placed on the site and viewable through a suitable webpage.

The LAA wishing to monitor that website implements a method to acquire information on the users of that website.

The LAA then approaches the Internet access provider managing the first network so as to configure the various instances of the interception software with the root of the website to be monitored as the reference URL. The interception software applications are run.

When the user of the client station 10 leaves a message on the website hosted by the server 20, the client station 10 transmits an HTTP request whereof the header includes the “POST” method, such that the receiving server 20 interprets the HTTP message contained in the HTTP request.

Similarly, when the user of the station 10 views a page on the website, the client station 10 sends an HTTP request whereof the header includes the “GET” method.

Owing to the passive interception software run on the interconnection equipment 100, the HTTP requests sent to the website accessible on the server 20 and passing through the equipment 100 are intercepted. They are duplicated and the copies are filtered. The HTTP requests including the URL of the monitored website are sent to the device 150. The original IP frames are absolutely not affected by the interception software, which guarantees normal operation from the user's perspective.

The number of incident HTTP requests on the processing servers is very high. The structure of the device 150 makes it possible to distribute the load between the different processing servers.

By running the processing software 210, the following processing steps are carried out at the server 200.

In an initial acquisition step 612, the module 212 stores a complete frame, corresponding to an incident HTTP request, in the addressable memory space of the server 200. A first pointer P1 is placed in a stack associated with that frame. The first pointer P1 indicates the memory address of the first bit of the frame to be filtered.

The method then continues through a selection step 614 consisting of an in-depth analysis of the binary structure of the frame.

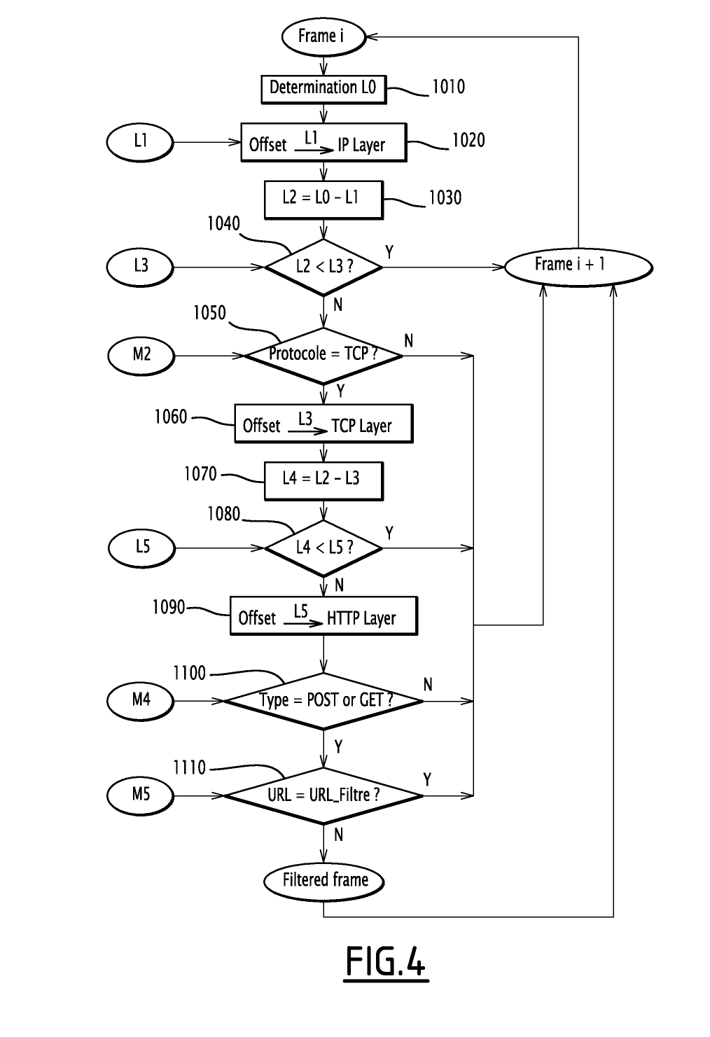

As shown in detail in FIG. 4, the selection step 614, which is carried out by running the selection module 214, begins by determining the length LO of the frame (step 1010 in FIG. 4).

The header of the transport layer of a frame (layers 2 of the OSI model) having a first predetermined length L1, a second pointer P2 is placed in the stack associated with the frame. The second pointer points toward an address of the memory space obtained by shifting the address indicated by the first pointer P1 by a length L1 (step 1020). In this way, the second pointer points to the first byte of the IP layer of the frame (level 3 layer of the OSI model).

The length L2 of the IP packet encapsulated in the frame is calculated in step 1030. This length L2 is obtained by subtracting the length L1 from the length L0.

The length L3 of the header of an IP packet is defined by the IP protocol. This length L3 makes it possible to verify a first condition that consists of comparing the length L2 of the IP packet to the length L3 (step 1040).

If the length L2 is smaller than the length L3, this means that the considered packet is not an IP packet. Consequently, the frame is rejected and the method goes on to the selection of the following frame.

However, if the length L2 is longer than the length L3, this means that, if it is in fact an IP packet, in addition to an IP header, it has an IP message potentially containing relevant data.

In step 1050, a second mask M2 is applied on the IP header of the IP packet (“HEADER” of the IP packet) so as to extract a second group of bits and compare it to a second expected binary value of the second parameter relative to the protocol used in the transport layer (level 4 layer of the OSI model), second parameter present in the IP header. In the present embodiment, the second expected value corresponds to the use of the TCP protocol.

At the end of verification of the second condition, if the value of the second protocol parameter is different from “TCP,” the frame is rejected and the method goes on to the selection of the following frame.

However, if the value of the second protocol parameter is equal to “TCP,” a third pointer P3 is placed, in step 1060, in the stack 213 associated with the frame. This third pointer points to an address obtained by shifting the address indicated by the second pointer P2 by a length L3. The third pointer indicates the beginning of the TCP layer of the frame.

In step 1070, a length L4 is calculated that corresponds to the length of the TCP packet. This length L4 is obtained by the difference between the length L2 and the length L3.

The length L5 of the header of a TCP packet is predetermined. This length L5 makes it possible to test a third condition that consists of comparing the length L4 of the TCP packet to the length L5 (step 1080).

If the length L4 is smaller than the length L5, this means that the considered packet is not a TCP packet. As a result, the frame is rejected and the method moves on to the selection of the following frame.

However, if the length L4 is greater than the length L5, in addition to a TCP header, the TCP packet includes a TCP message that may contain relevant information.

In step 1090, a fourth pointer P4 is placed in the stack associated with the frame. This fourth pointer points to an address that corresponds to the shift by a length L5 of the address indicated by the third pointer P3. The fourth pointer points to the beginning of the HTTP layer of the studied frame (application layers 5 to 7 of the OSI model).

Then, in step 1100, a fourth mask M4 is applied on the HTTP header so as to extract a fourth group of bits and compare it to a fourth expected binary value for a fourth type parameter of the HTTP packet. The fourth expected value is the “POST” value or the “GET” value of that method parameter.

If the HTTP method used is not one of the two previous methods, the frame is not considered and the method moves on to the step for selecting the following frame.

If the HTTP method is a POST or GET, in step 1110, a fifth mask M5 is applied on the HTTP header so as to compare part of the URL to a plurality of fifth undesired values corresponding to strings of reference characters.

If the comparison is positive, the frame is rejected; if not, the frame is selected.

The latter test for example makes it possible to dismiss HTTP requests including a message corresponding to an image, by mentioning the “.jpg” string in the list of strings of reference characters.

For a selected frame, the method continues with step 616 for extracting and reformatting HTTP data by running the module 216. The data extracted from the HTTP header of the HTTP request are the URL, the source IP address of the frame, the recipient IP address of the frame, the “User Agent,” i.e. the identifier of the browser used, and the “REFERER,” i.e. the URL of the webpage on which a hypertext link is located that the client wishes to follow to access the resource of the monitored website. This may be a link on an external page relative to the monitored website, but also a link on the monitored website.

Each of these pieces of data is kept in an associated variable.

Advantageously, additional data, called metadata, is associated with the processed frame. Thus, if the URL of the HTTP request corresponds to a reference URL0 which, in the configuration file 211, is associated with a particular type of matter, such as the “terrorism” type, the case type is a metadatum associated with the frame during step 616.

A set of data and metadata, making up a data message D, is ultimately stored in a buffer memory space of the processing server 200.

In step 618, the selection module 218 monitoring this buffer memory space recognizes that a new data message has just been left so as to be sent to a storage database.

The module 218 reads the table 219 to look for the address of a storage server 300, 302, 304 in the “free” state to which to send the data message. The module 218 selects a receiving storage server, for example the storage server 300.

The data message is therefore sent to the selected storage server. This message may be encrypted in AES 256. On the storage server 300, after a step 712 for acquiring the data message D, a decoding step 714 makes it possible to recover the data D that is stored in a file F.

A classification step 716 of the data file then makes it possible to choose an archiving directory for that file. The choice of a particular directory is made based on the metadata associated with the file F.

The step for storage in a database 301 associated with the storage server 300, step 718 in FIG. 3, is done by running the module 318, which continuously examines the filling level of each of the directories of the archiving structure. When the filling level of a directory exceeds a predetermined threshold, all of the contents of that directory are saved in the database 301, in a table with a predetermined format.

In step 812, off-line, through the man/machine interface 412 displayed on the screen of the retrieval server 400, a member of the LAA builds complex query requests for the databases 301, 303, 305. That member uses a metalanguage.

In step 814, these complex requests are sent to the consultation module 414, which translates them into as many requests using the SQL language allowing direct querying of the databases 301, 303 and/or 305. The data extracted from the various databases is repatriated on the retrieval server 400. The consultation module 414 aggregates that various data so that it is presented to the operator through the interface 412.

The processing device and method described above make it possible to process a large volume data flow using a single processing server computer including a motherboard having standard features. The scale of the processing device being easily adaptable to the needs, multiplying the number of computers making up each of the layers of the device makes it possible to process very high data flows using the device according to the invention. These high data flows are typically those found at the access point of a national sub-network of the Internet.

Through the in-depth processing of the HTTP request, i.e. at the binary level of the corresponding frame, the method avoids multiplying computation times and considerable elongation of processing times required for each request, while allowing a large quantity of data necessary to monitor the website and the activities of its users to be extracted.

1 to 10. (canceled)

11. A method for analyzing intercepted HTTP requests on an IP network to monitor the activity of the users of a predetermined website, comprising, performing, with one or more computers the steps of:
acquiring a complete data frame of an HTTP request;
selecting the acquired data frame if a binary structure thereof meets a plurality of conditions including at least one condition corresponding to the IP layer of the frame, at least one condition corresponding to a transport layer of the frame, and at least one condition corresponding to an application layer of the frame;
extracting data of interest from the application layer of the selected frame; and
recording the extracted data in a database.

12. The method according to claim 11, wherein the selecting step allows the selection of a frame whereof the transport layer is a TCP layer and the application layer is an HTTP layer.

13. The method according to claim 12, wherein, in the selecting step, the at least one condition on the IP layer, and the at least one condition on the TCP layer, repsectively, includes comparing a length of a packet of bits included in the acquired frame, the packet being an IP packet and a TCP packet, respectively, with a predefined header length of an IP packet and a TCP packet, respectively.

14. The method according to claim 12, wherein, in the selecting step, the at least one condition on the IP layer, and the at least one condition on the HTTP layer, respectively, includes applying, on a header of a packet of bits included in the acquired frame, the packet being an IP packet, and an HTTP packet, respectively, a mask to extract a group of bits and comparing the group of bits with an expected binary value for a parameter present in the header of an IP packet, and in the header of an HTTP packet, respectively.

15. The method according to a claim 11, further comprising the step of, shaping the extracted data according to a predetermined model between the extracting step and the recording step.

16. A device for implementing the method according to claim 11 comprising at least one computer, the at least one computer including:
an acquisition module for acquiring a complete data frame of the intercepted HTTP request on the IP communication network to which the device is connected;
a selection module for verifying a plurality of conditions on the binary structure of the acquired data frame which is obtained as output of the acquisition module, and having at least one routine for verifying a condition corresponding to the IP layer of the frame, at least one routine for verifying a condition corresponding to the transport layer of the frame, and at least one routine for verifying a condition corresponding to the application layer of the frame;
an extraction module for extracting data from the application layer of the selected data frame which is obtained as output of the selection module; and
a recording module for storing the extracted data which is obtained as output of the extraction module in a database.

17. The device according to claim 16, wherein the selection module is adapted to select and acquire data frames whereof the transport layer is a TCP layer and whereof the application layer is an HTTP layer.

18. The device according to claim 16, further comprising a processing stage including a plurality of processing server computers, each processing server computer being connected to the IP communication network and including an instantiation of the acquisition, selection and extraction modules.

19. The device according to claim 18, further comprising a storage stage including a plurality of storage server computers, each storage server computer being connected to the plurality of processing server computers, each storage server computer associated with at least one database, and including an instantiation of the recording module for storing the extracted data communicated by a processing server computer into the database associated with the respective storage server computer.

20. The device according to claim 19, further comprising a retrieval stage including at least one retrieval computer including for querying the various databases of the storage stage.

21. The method as recited in claim 15, wherein the shaping step includes associating metadata therewith.

22. Computer readable media, having stored thereon, computer executable instructions for performing a method comprising the method of claim 10.
